(19) United States
(12) Patent Application Publication
(10) Pub. No.: US 2024/0052903 A1
(43) Pub. Date: Feb. 15, 2024

(54) SPRING UNIT, ACTUATOR, AND METHOD FOR PRODUCING SPRING UNIT

(71) Applicant: Mitsubishi Electric Corporation, Tokyo (JP)

(72) Inventor: Shin UEGAKI, Tokyo (JP)

(73) Assignee: Mitsubishi Electric Corporation, Tokyo (JP)

(21) Appl. No.: 18/283,819

(22) PCT Filed: Apr. 26, 2021
(86) PCT No.: PCT/JP2021/016634

§ 371 Date: Sep. 25, 2023

(51) Int. Cl. F16F 1/26

(52) U.S. Cl. CPC F16F 1/26; F16F 2226/04; F16F 2224/02

(57) ABSTRACT

A spring unit includes a spring part including multiple plate-shaped leaf springs, a plate-shaped support part and a plate-shaped load part connected to opposite ends of each of the leaf springs in a first direction. Each of the leaf springs is defined by multiple sheet-shaped members laminated on one another in a thickness direction thereof. The multiple sheet-shaped members are bonded together by intermolecular force.

### FIELD

The present disclosure relates to a spring unit including a spring deformed upon application of load and restored to the original shape upon the removal of load. The present disclosure also relates to an actuator, and a method for producing a spring unit.

### BACKGROUND

A spring is a component that utilizes elastic deformation of a material. A spring is deformed upon application of a load, and restored to the original shape when unloaded. A spring is classified into one of a coil spring, a disc spring, a leaf spring, and the like. Patent Literature 1 discloses a method for producing a coil spring having an outer shape of 200 nanometers (nm) and an inner diameter of 100 nm, the coil spring being formed of a metal or an alloy containing a magnetic transition metal.

### CITATION LIST

### Patent Literature

Patent Literature 1: Japanese Patent Application Laid-open No. 2018-193607

### SUMMARY OF INVENTION

Problem to be solved by the Invention

However, a coil spring produced using the conventional technology described in Patent Literature 1 suffers from a problem of failure to achieve large displacement because of mutual contact between portions of wire when the coil spring is compressed. A leaf spring, which utilizes flexure of a plate, can achieve large displacement when compressed. Unfortunately, a large-size plate is required for achieving a wide reversible deformation range using a leaf spring, which presents a problem of the need for a large space for installing a leaf spring.

The present disclosure has been made in view of the foregoing, and it is an object of the present disclosure to provide a spring unit having a wider reversible deformation range than that of a conventional coil spring, and reducing the space for installation as well, as compared to the conventional leaf spring.

### Means to Solve the Problem

To solve the problem and achieve the object described above, a spring unit according to the present disclosure comprises: a spring part comprising a plurality of plate-shaped leaf springs; and a plate-shaped support part and a plate-shaped load part connected to opposite ends of each of the leaf springs in a first direction. Each of the leaf springs is defined by a plurality of sheet-shaped members laminated on one another in a thickness direction thereof. The plurality of sheet-shaped members are bonded together by intermolecular force

### Effects of the Invention

A spring unit according to the present disclosure is advantageous in having a wider reversible deformation range than that of a conventional coil spring, and reducing the space for installation as well, as compared to the conventional leaf spring.

### BRIEF DESCRIPTION OF DRAWINGS

FIG. 1 is a perspective view schematically illustrating an example of configuration of a spring unit according to a first embodiment.

FIG. 2 is a perspective view schematically illustrating an example of configuration of a leaf spring of the spring unit according to the first embodiment.

FIG. 3 is a plan view illustrating an example of atomic-scale structure of graphene.

FIG. 4 is a side view illustrating an example of atomic-scale structure of graphene.

FIG. 5 is a plan view illustrating an example of atomic-scale structure of molybdenum disulfide.

FIG. 6 is a side view illustrating an example of atomic-scale structure of molybdenum disulfide.

FIG. 7 is a cross-sectional view illustrating an example of configuration of the spring unit according to the first embodiment.

FIG. 8 is a diagram for describing an effect of the spring unit illustrated in FIG. 7.

FIG. 9 is a diagram for describing an effect of the spring unit illustrated in FIG. 7.

FIG. 10 is a cross-sectional view schematically illustrating another example of configuration of the spring unit according to the first embodiment.

FIG. 11 is a diagram schematically illustrating an example of configuration of an actuator according to a second embodiment.

FIG. 12 is a diagram schematically illustrating another example of configuration of the actuator according to the second embodiment.

FIG. 13 is a diagram schematically illustrating still another example of configuration of the actuator according to the second embodiment.

FIG. 14 is a diagram schematically illustrating still another example of configuration of the actuator according to the second embodiment.

### DESCRIPTION OF EMBODIMENTS

A spring unit, an actuator, and a method for producing a spring unit according to embodiments of the present disclosure will be described in detail below with reference to the drawings.

### First Embodiment

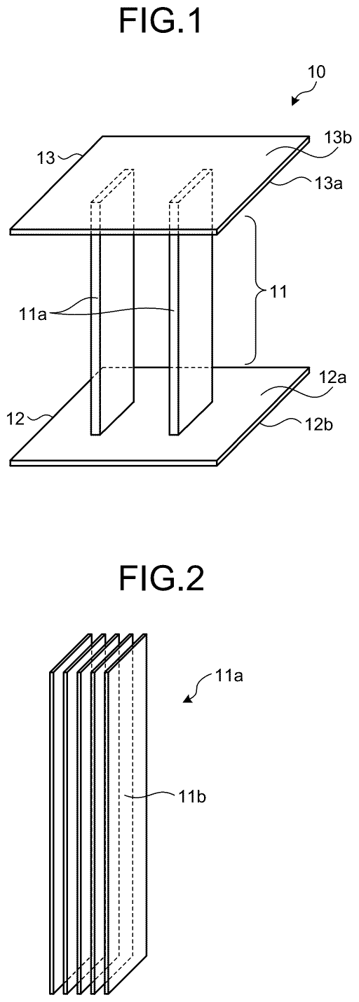

FIG. 1 is a perspective view schematically illustrating an example of configuration of a spring unit according to a first embodiment. A spring unit 10 includes a spring part 11, and a support part 12 and a load part 13. Each of the support part 12 and the load part 13 has a plate shape, and is connected to the spring part 11.

The spring part 11 includes multiple leaf springs 11a each having a plate shape. The leaf springs 11a each have surfaces perpendicular to a thickness direction thereof. These perpendicular surfaces are connected, at predetermined angles, to a connection surface 12a of the support part 12 and a connection surface 13a of the load part 13. The connection surface 12a is a surface connected to the spring part 11, and the connection surface 13a is a surface connected to the spring part 11. In one example, the perpendicular surfaces of the leaf spring 11a are connected perpendicularly to the connection surface 12a of the support part 12 and the connection surface 13a of the load part 13.

FIG. 2 is a perspective view schematically illustrating an example of configuration of the leaf springs of the spring unit according to the first embodiment. Each of the leaf springs 11a is configured to include multiple sheet-shaped members 11b laminated on one another in a thickness direction of the sheet-shaped members 11b. The multiple sheet-shaped members 11b defining the leaf spring 11a have surfaces perpendicular to the thickness direction thereof, and these perpendicular surfaces are disposed in parallel to one another. The sheet-shaped members 11b laminated on one another are bonded together by intermolecular force rather than by metallic bond found in iron etc. used in the material of the conventional leaf springs.

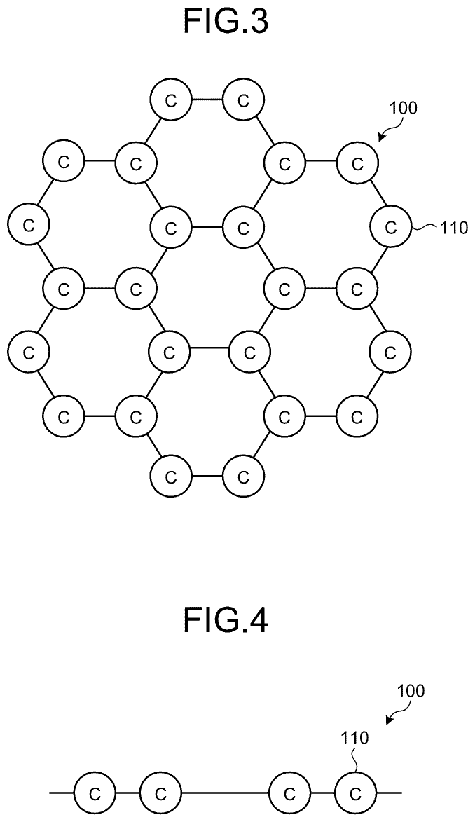

The sheet-shaped members 11b may be formed of a material that is a two-dimensional material having a two-dimensional bonding structure of atoms. An example of the two-dimensional material is at least one material selected from the group consisting of graphene, hexagonal boron nitride, molybdenum disulfide, molybdenum telluride, indium selenide, and tin telluride. FIG. 3 is a plan view illustrating an example of atomic-scale structure of graphene. FIG. 4 is a side view illustrating an example of atomic-scale structure of graphene. Graphene 100 is a sheet-shaped material having carbon atoms 110 bonded together to each other by covalent bond in such a manner to form hexagons on the same plane. As described above, adjacent layers of the graphene 100 are bonded together by intermolecular force.

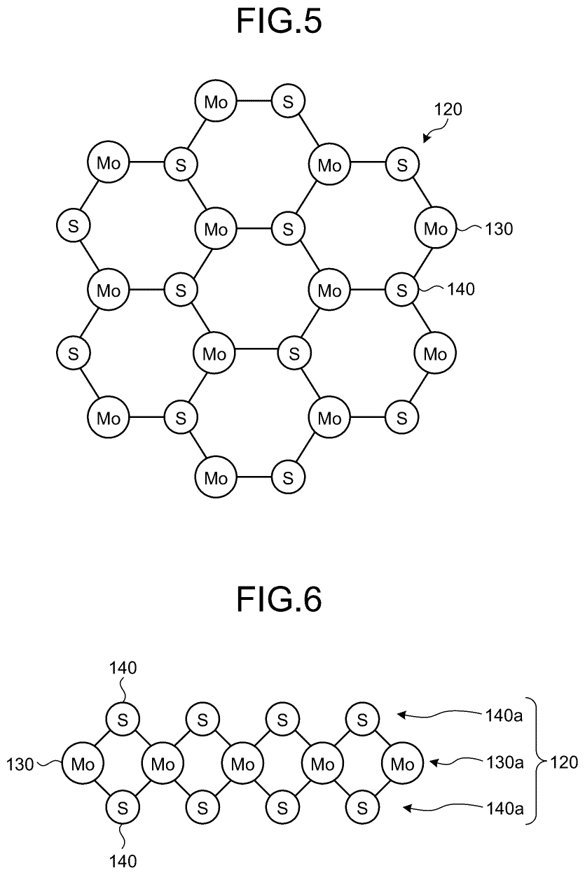

FIG. 5 is a plan view illustrating an example of atomic-scale structure of molybdenum disulfide. FIG. 6 is a side view illustrating an example of atomic-scale structure of molybdenum disulfide. A molybdenum disulfide layer 120, which is a sheet-shaped material, includes a molybdenum layer 130a and sulfur layers 140a. The molybdenum layer 130a includes molybdenum atoms 130 arranged in a triangle on the same plane. The sulfur layer 140a includes sulfur atoms 140 arranged in a triangle. One of the sulfur layers 140a is disposed above the molybdenum layer 130a, and the other below the molybdenum layer 130a. When viewed from a direction perpendicular to the sheet, the molybdenum layer 130a and the sulfur layers 140a are disposed in such a manner that the triangle of the molybdenum layer 130a and the triangle of the sulfur layer 140a form a hexagon. Each of the molybdenum atoms 130 in the molybdenum layer 130a and the corresponding sulfur atoms 140 in the sulfur layers 140a are bonded together by covalent bond to form the single molybdenum disulfide layer 120. Adjacent ones of the molybdenum disulfide layers 120 are bonded together by intermolecular force.

As described above, the atoms of the sheet of each of the sheet-shaped members 11b are bonded together by covalent bond rather than by metallic bond found in iron etc. used in the material of the conventional leaf springs. The material of the sheet-shaped members 11b thus has high rigidity in an in-plane direction and has bending flexibility in an out-of-plane direction.

Reference is made back to FIG. 1. The support part 12 is a member that supports the spring part 11. The support part 12 is a plate-shaped member having the connection surface 12a and a support surface 12b. The connection surface 12a is to be connected to the spring part 11, and a support surface 12b is a surface opposite the connection surface 12a. In one example, the support part 12 has a shape having a pair of parallel surfaces defined by the connection surface 12a and the support surface 12b. The spring unit 10 is supported by an object in such a manner that the support surface 12b of the support part 12 contacts that object.

The load part 13 is a member provided between the spring part 11 and a load member that applies a load to the spring part 11. The plate-shaped leaf springs 11a have portions connected to the support part 12, and portions opposite those connected portions. The load part 13 is provided at these opposite portions of the leaf springs 11a. That is, in the example of FIG. 1, each of the leaf springs 11a has its opposite ends in a direction of extension of the leaf spring 11a, and the support part 12 and the load part 13 are connected to the opposite ends of each leaf spring 11a. The direction of extension is defined as a first direction. The load part 13 is a plate-shaped member having the connection surface 13a and a load surface 13b. The connection surface 13a is to be connected to the spring part 11, and a load surface 13b is a surface opposite the connection surface 13a. In one example, the load part 13 has a shape having a pair of parallel surfaces defined by the connection surface 13a and the load surface 13b. The spring unit 10 is provided in such a manner that the load member contacts the load surface 13b of the load part 13.

A mechanism of deformation of the spring part 11 will be described below. Assume that a load having a component directed from the load surface 13b toward the connection surface 13a of the load part 13 is applied to the load surface 13b of the load part 13 at an angle relative to the load surface 13b. In this case, the laminated multiple sheet-shaped members 11b defining the leaf spring 11a remain bonded together by intermolecular force, undergoing tensile strain on an outside of the bend and compressive strain on an inside of the bend. As a result, the leaf spring 11a is deformed. Application of a higher load in this state breaks the bonding provided by intermolecular force between the laminated multiple sheet-shaped members 11b defining the leaf spring 11a. This causes slippage or delamination between the sheet-shaped members 11b or wrinkling in the sheet-shaped members 11b, thereby deforming the leaf spring 11a. Once the bonding provided by intermolecular force is broken, instability in energy occurs between the sheet-shaped members 11b, thereby providing almost zero resistance to slip.

When the load applied to the load part 13 is thereafter removed, strain energy stored in the leaf spring 11a acts as driving force to cause the leaf spring 11a to recover from the deformation. Then, when the load part 13 returns to the earlier position than the load is applied thereto, the sheet-shaped members 11b become bonded together again by intermolecular force. After removal of the load applied to the load part 13, thus, the spring part 11 recovers from deformation. As discussed above, the leaf spring 11a defined by the laminated sheet-shaped members 11b will have an unstable interlayer energy state even when the leaf spring 11a is deformed to such an extent that the surfaces on the inside of the bend of the leaf spring 11a come into contact with each other. This easily causes delamination of the sheet-shaped members 11b, such that the leaf spring 11a is reversibly deformed according to the above mechanism of deformation. This makes the reversible deformation range of the spring unit 10 greater than the reversible deformation range of the conventional technology.

Description will now be given assuming that the sheet-shaped members 11b are formed of graphene, and a load having a component directed from the load surface 13b toward the connection surface 13a is applied to the load surface 13b of the load part 13 at an angle relative to the load surface 13b. In this case, the leaf spring 11a is deformed as tensile strain occurs on an outside of the bend and compressive strain occurs on an inside of the bend until shear stress occurring between layers of the sheet-shaped members 11b exceeds 600 Mpa, or until normal stress occurring in the normal direction of the sheet-shaped members 11b exceeds 2000 MPa. Then, when the shear stress occurring between layers becomes 600 MPa or more, bonding by intermolecular force is broken, which in turn causes slippage of the layers relative to one another.

Alternatively, when the normal stress occurring in the normal direction of the sheet-shaped members 11b becomes 2000 MPa or more, bonding by intermolecular force is broken, which in turn causes delamination. As a result, the leaf spring 11a is deformed. Upon slippage or delamination of the sheet-shaped members 11b, the sheet-shaped members 11b may wrinkle accordingly. When the load applied to the load part 13 is thereafter removed, the deformed shape returns to the original shape under driving force provided by spontaneous restoring force due to strain energy stored in the sheet-shaped members 11b and slippage-caused surface energy of graphene. In addition, the sheet-shaped members 11b are bonded together by intermolecular force, thereby causing the leaf spring 11a to recover from deformation.

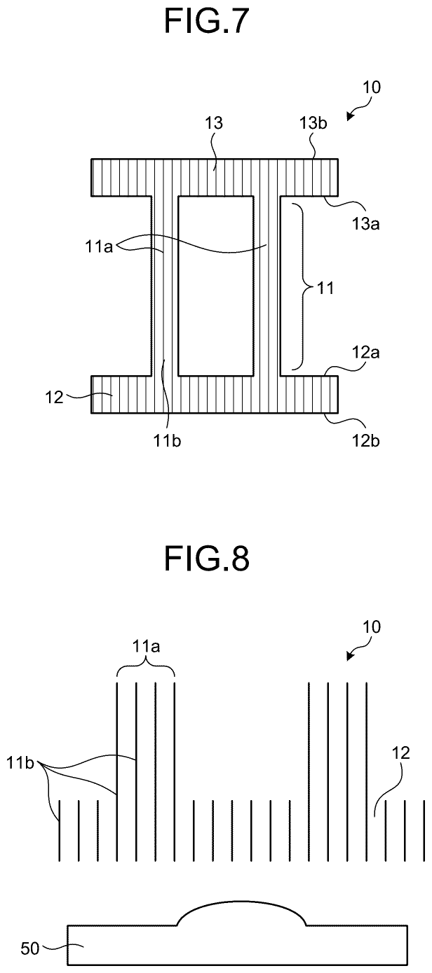

The spring part 11, the support part 12, and the load part 13 of the spring unit 10 according to the first embodiment may be formed of different materials or the same material. FIG. 7 is a cross-sectional view illustrating an example of configuration of the spring unit according to the first embodiment. In the example illustrated in FIG. 7, the spring part 11, the support part 12, and the load part 13 of the spring unit 10 are formed of the same material. The sheet-shaped members 11b defining each of the leaf springs 11a extend from the connection surface 12a connected to the support part 12 to the support surface 12b opposite thereto, and from the connection surface 13a connected to the load part 13 to the load surface 13b opposite thereto. In addition, the load part 13 and the support part 12 are formed by laminating the sheet-shaped members 11b on one another in the same direction as the direction of lamination of the leaf springs 11a at the disposition positions of the support part 12 and of the load part 13. That is, the support part 12 and the load part 13 are formed integrally with the spring part 11 at the opposite end portions of each of the leaf spring 11a in the direction of extension of the leaf spring 11a, and are defined by the sheet-shaped members 11b laminated in the thickness direction.

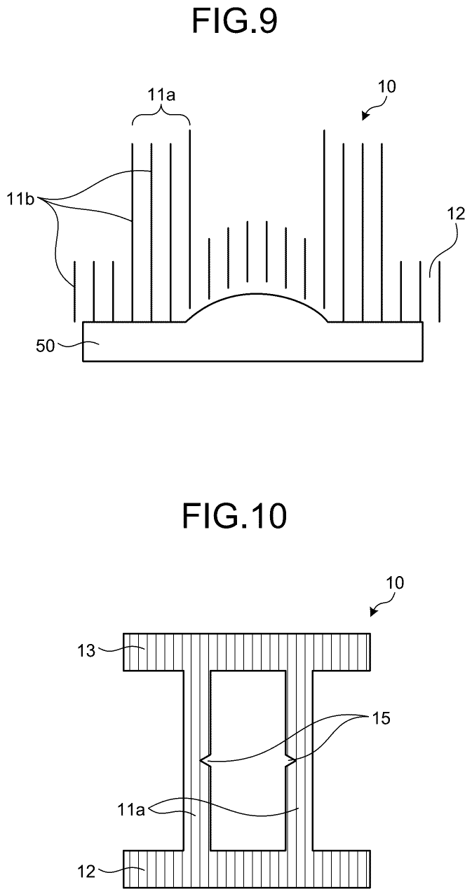

FIGS. 8 and 9 are each a diagram for describing an effect of the spring unit illustrated in FIG. 7. FIG. 8 illustrates the spring unit 10 that is to be fixed on a placement surface 50 having convex and recessed portions. In this case, the sheet-shaped members 11b defining the support part 12 slip with respect to each other upon placement of the spring unit 10, thereby conforming the shape of the support part 12 to the shape of the placement surface 50 as illustrated in FIG. 9. Such shape removes stress concentration on the support part 12 and the placement surface 50 when a load is applied to the load part 13. This provides an advantageous effect that the spring unit 10 can bear high load, i.e., withstand large displacement.

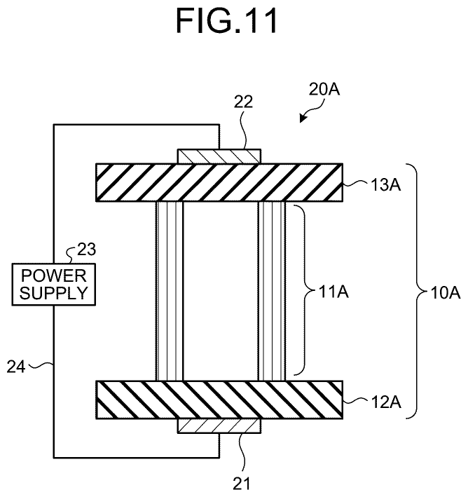

FIG. 10 is a cross-sectional view schematically illustrating another example of configuration of the spring unit according to the first embodiment. FIG. 10 illustrates the leaf springs 11a each having a cutout portion 15 having a predetermined depth. The sheet-shaped members 11b defining the leaf spring 11a includes a predetermined number of consecutive layers of the sheet-shaped members 11b having a hole formed therethrough from one of the perpendicular surfaces of the leaf spring 11a to the thickness direction of the leaf spring 11a. In addition, the predetermined number of layers of sheet-shaped members 11b are laminated on one another in such a manner as to align hole portions of the sheet-shaped members 11b with one another. In this configuration, the hole of the sheet-shaped member 11b is in part or entirely, i.e., at least partially aligned with the hole of the adjacent sheet-shaped member 11b. The portions having the holes aligned with one another define the cutout portion 15. Examples of the shape of the holes include a circle, a triangle, and a quadrangle. The holes may have sizes that gradually increase or decrease, toward inner layers of the leaf spring 11a, from the sheet-shaped member 11b having one of the perpendicular surfaces of the sheet-shaped member 11b to the thickness direction.

When a load is applied to the load part 13 of the spring unit 10 having the cutout portions 15 illustrated in FIG. 10, the leaf springs 11a are deformed bringing the surfaces having the notched portions 15 into concave shapes. As a result, the shape of deformation of the leaf springs 11a is controllable as compared with the leaf springs 11a having no cutout portions 15.

A method for producing the spring unit 10 illustrated in FIG. 7 will next be described. A base material is prepared. The base material is larger in size than the spring unit 10 to be produced, and includes, in at least part, the sheet-shaped members 11b laminated on one another in the same direction. A focused ion beam (FIB) system is used to produce the spring unit 10 by removing portions other than the spring part 11, the support part 12, and the load part 13 from a region of this base material in which the sheet-shaped members 11b are laminated on one another in the same direction. Specifically, an ion beam is emitted from a direction parallel or perpendicular to the thickness direction of the sheet-shaped members 11b and parallel to the connection surfaces 12a and 13a of the support part 12 and the load part 13. The thus emitted ions then sputter atoms of the base material to thereby remove the portions other than the components of the spring unit 10. Examples of the ion for use in the ion beam include a gallium ion, a neon ion, and a helium ion.

When the spring unit 10 is formed of graphene, highly oriented pyrolytic graphite (HOPG) etc. is used as the base material. HOPG is obtained by pyrolysis of hydrocarbon gas, allowing pyrolysate to deposit into pyrolytic carbon, and performing high temperature heat treatment of the pyrolytic carbon with stress applied thereto.

The spring unit 10 according to the first embodiment includes the spring part 11 defined by the plate-shaped multiple leaf springs 11a, and the plate-shaped support part 12 and the plate-shaped load part 13 connected to opposite end portions of each of the leaf springs 11a. Each of the leaf springs 11a is defined by the multiple sheet-shaped members 11b laminated on one another in the thickness direction. The multiple sheet-shaped members 11b are bonded together by intermolecular force. When a load higher than a predetermined load is applied to the load part 13, the bonding provided by intermolecular force between the sheet-shaped members 11b defining each leaf spring 11a is broken to thereby cause slippage or delamination between the sheet-shaped members 11b, or wrinkling in the sheet-shaped members 11b, such that the spring part 11 is deformed. In addition, upon unloading to remove the load, the deformed shape returns to the original shape due to strain energy stored in the sheet-shaped members 11b during loading, and at the same time, the sheet-shaped members 11b become bonded together again by intermolecular force therebetween, thereby recovering from the deformation. As described above, it becomes possible to achieve an advantageous effect of providing the spring unit 10 having a wider reversible deformation range than the reversible deformation range of a conventional coil spring. In order for a conventional leaf spring to achieve a wide reversible deformation range, a large-size plate needs using, which requires a large space for installing a leaf spring. In contrast, the spring unit 10 according to the first embodiment includes the leaf springs 11a each configured to include the multiple sheet-shaped members 11b bonded together by intermolecular force and having high rigidity in an in-plane direction and having bending flexibility in an out-of-plane direction. It thus becomes possible to form the leaf springs 11a having a wide reversible deformation range irrespective of the size thereof. This results in an advantageous effect of reducing the space for installing the spring unit 10 as compared to a conventional leaf spring.

### Second Embodiment

A second embodiment will be described as to an actuator using the spring unit 10 described in the first embodiment.

FIG. 11 is a diagram schematically illustrating an example of configuration of an actuator according to the second embodiment. An actuator 20A includes a spring unit 10A an electrode 21, an electrode 22, a power supply 23, and a conductor wire 24. The spring unit 10A includes a spring part 11A, a support part 12A, and a load part 13A. The electrode 21 is provided on the support surface 12b of the support part 12A. The electrode 22 is provided on the load surface 13b of the load part 13A. The a power supply 23 applies a voltage between the electrodes 21 and 22. The conductor wire 24 electrically interconnects the power supply 23 and each of the electrodes 21 and 22. In FIG. 11, the spring unit 10A, the spring part 11A, the support part 12A, and the load part 13A correspond to the spring unit 10, the spring part 11, the support part 12, and the load part 13 of the first embodiment, respectively. However, the spring part 11A, the support part 12A, and the load part 13A are formed of an electrically insulating material. The electrodes 21 and 22 are formed of an electrically conductive material. The electrode 21 corresponds to a first electrode, and the electrode 22 corresponds to a second electrode. The conductor wire 24 is formed of an electrically conductive material, and preferably has a low resistance. The power supply 23 may be either a direct current power supply or an alternating current power supply. FIG. 11 illustrates a single electrode 21 and a single electrode 22 connected to the support part 12A and to the load part 13A, respectively, but the numbers of the electrodes 21 and 22 to be connected to the support part 12A and to the load part 13A may each be two or more.

In the actuator 20A illustrated in FIG. 11, when the power supply 23 is operated to apply a voltage between the electrode 21 connected to the support part 12A and the electrode 22 connected to the load part 13A, static electricity produces force between the electrodes 21 and 22 in a direction to compress the spring part 11A. The magnitude of the generated force changes depending on the magnitude of the voltage, and the amount of deformation of the spring part 11A changes depending on the magnitude of the generated force. When the voltage between the electrodes 21 and 22 is reduced to zero, electrostatic force disappears, such that under the action of restoring force of the leaf springs 11a defining the spring part 11A, the shape of the spring part 11A returns to the initial state that precedes the deformation.

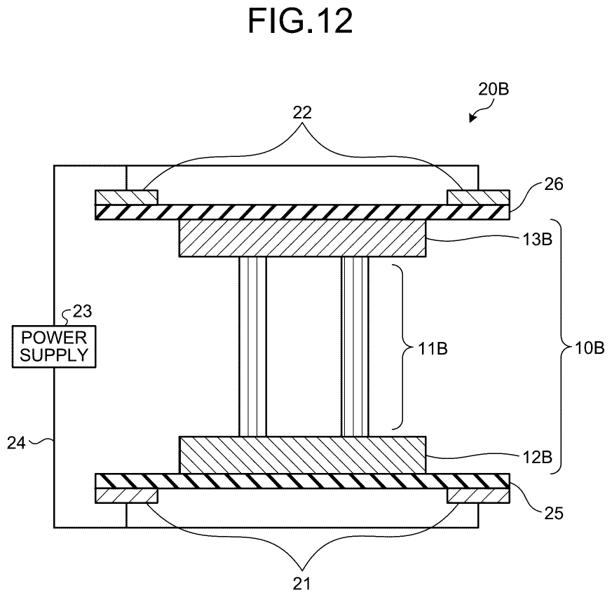

FIG. 12 is a diagram schematically illustrating another example of configuration of the actuator according to the second embodiment. Note that the same components as the components of FIG. 11 are designated by like reference characters, and description thereof will be omitted. An actuator 20B includes a spring unit 10B, an insulation layer 25, an insulation layer 26, the electrodes 21, the electrodes 22, the power supply 23, and the conductor wire 24. The spring unit 10B includes a spring part 11B, a support part 12B, and a load part 13B. The insulation layer 25 is provided on the support surface 12b of the support part 12B. The insulation layer 26 is provided on the load surface 13b of the load part 13B. The electrodes 21 are connected to the insulation layer 25. The electrodes 22 are connected to the insulation layer 26. The power supply 23 applies a voltage between the electrodes 21 and 22. The conductor wire 24 electrically interconnects the power supply 23 and each of the electrodes 21 and 22. In FIG. 12, the spring unit 10B, the spring part 11B, the support part 12B, and the load part 13B correspond to the spring unit 10, the spring part 11, the support part 12, and the load part 13 of the first embodiment, respectively. However, the spring part 11B, the support part 12B, and the load part 13B are formed of an electrically conductive material. The insulation layer 25 corresponds to a first insulation layer, and the insulation layer 26 corresponds to a second insulation layer.

In the example of FIG. 12, the insulation layers 25 and 26 are illustrated as having areas larger than the areas of the support part 12B and of the load part 13B. The multiple electrodes 21 are provided on portions of the surface of the insulation layer 25 opposite the surface of the insulation layer 25 connected to the support part 12B, which portions are not at a position corresponding to the disposition position where the spring unit 10B is disposed. The multiple electrodes 22 are provided on portions of the surface of the insulation layer 26 opposite the surface connected to the load part 13B, which portions are not at a position corresponding to the disposition position where the spring unit 10B is disposed. Note that FIG. 12 illustrates the two electrodes 21 connected to the support part 12B and the two electrodes 22 connected to the load part 13B, but the numbers of the electrodes 21 and 22 to be connected to the support part 12B and the load part 13B may each be three or more or one. In addition, FIG. 12 illustrates the electrodes 21 and 22 provided at positions not overlapping the disposition position of the spring unit 10B, but the electrodes 21 and 22 may be provided at positions overlapping the disposition position of the spring unit 10.

In the actuator 20B illustrated in FIG. 12, when the power supply 23 is operated to apply a voltage between the electrodes 21 connected to the support part 12B via the insulation layer 25 and the electrodes 22 connected to the load part 13 via the insulation layer 26, static electricity produces force between the electrodes 21 and 22 in a direction to compress the spring part 11B. The magnitude of the generated force changes depending on the magnitude of the voltage, and the amount of deformation of the spring part 11B changes depending on the magnitude of the generated force. When the voltage between the electrodes 21 and 22 is reduced to zero, electrostatic force to disappear, such that under the action of restoring force of the leaf springs 11a defining the spring part 11B, the shape of the spring part 11B returns to the initial state that precedes the deformation.

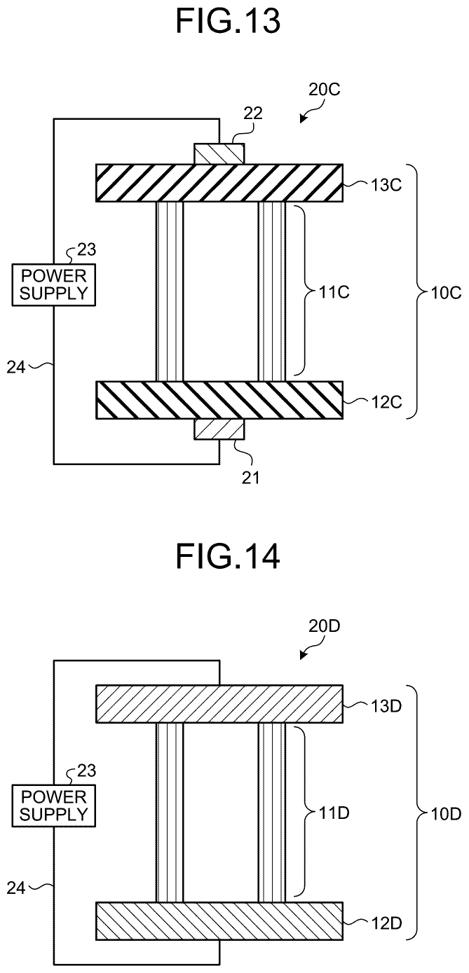

FIG. 13 is a diagram schematically illustrating still another example of configuration of the actuator according to the second embodiment. Note that the same components as the components of FIG. 11 are designated by like reference characters, and description thereof will be omitted. An actuator 20C includes a spring unit 10C, the electrode 21, the electrode 22, the power supply 23, and the conductor wire 24. The spring unit 10C includes a spring part 11C, a support part 12C, and a load part 13C. The electrode 21 is provided on the support surface 12b of the support part 12C. The electrode 22 is provided on the load surface 13b of the load part 13C. The power supply 23 applies a voltage between the electrodes 21 and 22. The conductor wire 24 electrically interconnects the power supply 23 and each of the electrodes 21 and 22. In FIG. 13, the spring unit 10C, the spring part 11C, the support part 12C, and the load part 13C correspond to the spring unit 10, the spring part 11, the support part 12, and the load part 13 of the first embodiment, respectively. However, the spring part 11C is formed of an electrically conductive material, and the support part 12C and the load part 13C are formed of an electrically insulating material. The electrode 21 is provided in a portion of the support surface 12b of the support part 12, which portion has the spring part 11C not disposed therein, i.e., has none of the leaf springs 11a disposed therein. The electrode 22 is provided in a portion of the load surface 13b of the load part 13, which portion has none of the leaf springs 11a disposed therein. Note that this is merely by way of example. The electrode 21 may be provided in a portion of the support surface 12b of the support part 12, which portion has the leaf spring 11a disposed therein, and the electrode 22 may be provided in a portion of the load surface 13b of the load part 13, which portion has the leaf springs 11 disposed therein.

In the actuator 20C illustrated in FIG. 13, when the power supply 23 is operated to apply a voltage between the electrode 21 connected to the support part 12C and the electrode 22 connected to the load part 13, static electricity produces force between the electrodes 21 and 22 in a direction to compress the spring part 11C. The magnitude of the generated force changes depending on the magnitude of the voltage, and the amount of deformation of the spring part 11C changes depending on the magnitude of the generated force. When the voltage between the electrodes 21 and 22 is reduced to zero, electrostatic force disappears, such that under the action of restoring force of the leaf springs 11a defining the spring part 11C, the shape of the spring part 11C returns to the initial state that precedes the deformation.

FIG. 14 is a diagram schematically illustrating still another example of configuration of the actuator according to the second embodiment. Note that the same components as the components of FIG. 11 are designated by like reference characters, and description thereof will be omitted. An actuator 20D includes a spring unit 10D, the power supply 23, and the conductor wire 24. The spring unit 10D includes a spring part 11D, a support part 12D, and a load part 13D. The power supply 23 applies a voltage between the support part 12D and the load part 13D. The conductor wire 24 electrically interconnects the power supply 23 and the support part 12D, and interconnects the power supply 23 and the load part 13D. In FIG. 14, the spring unit 10D, the spring part 11D, the support part 12D, and the load part 13D correspond to the spring unit 10, the spring part 11, the support part 12, and the load part 13 of the first embodiment, respectively. However, the spring part 11D is formed of an electrically insulating material, and the support part 12D and the load part 13D are formed of an electrically conductive material. In addition, the support part 12D and the load part 13D also serve as the electrodes 21 and 22 of the first embodiment.

In the actuator 20D illustrated in FIG. 14, when the power supply 23 is operated to apply a voltage between the support part 12D and the load part 13D, static electricity produces force between the support part 12D and the load part 13D in a direction to compress the spring part 11D. The magnitude of the generated force changes depending on the magnitude of the voltage, and the amount of deformation of the spring part 11D changes depending on the magnitude of the generated force. When the voltage across the support part 12D and the load part 13D is reduced to zero, electrostatic force disappears, such that under the action of restoring force of the leaf springs 11a defining the spring part 11D, the shape of the spring part 11D returns to the initial state that precedes the deformation.

For actuators 20A, 20B, 20C, and 20D of the second embodiment, the leaf springs 11a is deformed according to the magnitude of a voltage applied between the support parts 12A, 12B, 12C, and 12D and the load parts 13A, 13B, 13C, and 13D of the spring units 10A, 10B, 10C, and 10D that include the spring parts 11A, 11B, 11C, and 11D, the support parts 12A, 12B, 12C, and 12D, and the load parts 13A, 13B, 13C, and 13D, respectively. When force having a magnitude higher than or equal to a predetermined value in a direction to compress the spring parts 11A, 11B, 11C, and 11D is applied between the support parts 12A, 12B, 12C, and 12D and the load parts 13A, 13B, 13C, and 13D, the bonding provided by intermolecular force between the sheet-shaped members 11b defining the leaf springs 11a is broken to thereby cause slippage or delamination between the sheet-shaped members 11b or wrinkling in the sheet-shaped members 11b, such that the leaf springs 11a is deformed. In addition, upon removal of the force in the direction to compress the spring parts 11A, 11B, 11C, and 11D between the support parts 12A, 12B, 12C, and 12D and the load parts 13A, 13B, 13C, and 13D, the deformed shape returns to the original shape due to strain energy stored in the sheet-shaped members 11b during compression, and at the same time, the sheet-shaped members 11b become bonded together again by intermolecular force, thereby recovering from the deformation. As described above, it becomes possible to achieve an advantageous effect of providing the actuators 20A, 20B, 20C, and 20D each having a wider reversible deformation range than when a conventional coil spring is used. In order for a conventional leaf spring to achieve a wide reversible deformation range, a large-size plate needs using, which requires a large space for installing a leaf spring. In contrast, the leaf springs 11a of each of the actuators 20A, 20B, 20C, and 20D according to the second embodiment are each configured to include the multiple sheet-shaped members 11b bonded together by intermolecular force and having high rigidity in an in-plane direction and having bending flexibility in an out-of-plane direction. It thus becomes possible to form the leaf springs 11a having a wide reversible deformation range irrespective of the size thereof. This results in an advantageous effect of reducing the space for installing the spring units 10A, 10B, 10C, and 10D as compared to a conventional leaf spring, and providing the actuators 20A, 20B, 20C, and 20D having a wide reversible deformation range with a reduced size as compared to the size in the conventional technology.

The configurations described in the foregoing embodiments are merely examples. These configurations may be combined with a known other technology, and configurations of different embodiments may be combined together. Moreover, part of such configurations may be omitted and/or modified without departing from the spirit thereof.

### REFERENCE SIGNS LIST

10, 10A, 10B, 10C, 10D spring unit; 11, 11A, 11B, 11C, 11D spring part; 11a leaf spring; 11b sheet-shaped member; 12, 12A, 12B, 12C, 12D support part; 12a, 13a connection surface; 12b support surface; 13, 13A, 13B, 13C, 13D load part; 13b load surface; 15 notched portion; 20A, 20B, 20C, 20D actuator; 21, 22 electrode; 23 power supply; 24 conductor wire; 25, 26 insulation layer; 50 placement surface; 100 graphene; 110 carbon atom; 120 molybdenum disulfide layer; 130 molybdenum atom; 130a molybdenum layer; 140 sulfur atom; 140a sulfur layer.

1. A spring unit comprising:
a spring part comprising a plurality of plate-shaped leaf springs; and
a plate-shaped support part and a plate-shaped load part connected to opposite ends of each of the leaf springs in a first direction, wherein
each of the leaf springs is defined by a plurality of sheet-shaped members laminated on one another in a thickness direction thereof, and
the plurality of sheet-shaped members are bonded together by intermolecular force.

2. The spring unit according to claim 1, wherein
the plurality of sheet-shaped members defining the leaf springs have surfaces perpendicular to the thickness direction, the surfaces being parallel to one another, and
the perpendicular surfaces of each of the leaf springs to the thickness direction are connected to the load part and the support part at a predetermined angle.

3. The spring unit according to claim 1, wherein
the spring part, the load part, and the support part are formed of the same material, and
the support part and the load part are formed integrally with the spring part at opposite end portions of each of the leaf springs in the first direction, the support part and the load part being defined by the sheet-shaped members laminated on one another in the thickness direction.

4. The spring unit according to claim 1, wherein
the sheet-shaped members defining each of the leaf springs includes a predetermined number of layers of the sheet-shaped members having a hole formed therethrough from one of the perpendicular surfaces of each of the leaf springs to the thickness direction, and
the predetermined number of layers of the sheet-shaped members are laminated on one another in such a manner as to at least partially align hole positions of the sheet-shaped members with one another.

5. The spring unit according to claim 1, wherein the sheet-shaped members contain a two-dimensional material.

6. The spring unit according to claim 5, wherein the two-dimensional material is at least one material selected from the group consisting of graphene, hexagonal boron nitride, molybdenum disulfide, molybdenum telluride, indium selenide, and tin telluride.

7. An actuator comprising:
the spring unit according to claim 1;
a first electrode connected to the support part;
a second electrode connected to the load part; and
a power supply connected to the first electrode and to the second electrode via a conductor wire, wherein
the spring part, the support part, and the load part are formed of an electrically insulating material.

8. An actuator comprising:
the spring unit according to claim 1;
a first insulation layer formed of an electrically insulating material, the first insulation layer being connected to a surface of the support part, the surface being opposite a surface of the support part connected to the spring part;
a first electrode connected to the first insulation layer;
a second insulation layer formed of an electrically insulating material, the second insulation layer being connected to a surface of the load part opposite a surface of the load part connected to the spring part;
a second electrode connected to the second insulation layer; and
a power supply connected to the first electrode and to the second electrode via a conductor wire, wherein
the spring part, the support part, and the load part are formed of an electrically conductive material.

9. The actuator according to claim 8, wherein
the first insulation layer has an area larger than an area of the support part,
the second insulation layer has an area larger than an area of the load part,
the first electrode is provided on the first insulation layer at a position other than a position corresponding to a disposition position of the support part, and
the second electrode is provided on the second insulation layer at a position other than a position corresponding to a disposition position of the load part.

10. An actuator comprising:
the spring unit according to claim 1;
a first electrode connected to the support part;
a second electrode connected to the load part; and
a power supply connected to the first electrode and the second electrode via a conductor wire, wherein
the spring part is formed of an electrically conductive material, and
the support part and the load part are formed of an electrically insulating material.

11. The actuator according to claim 10, wherein
the first electrode is provided on the support part at a position other than a position corresponding to a disposition position of the spring part, and
the second electrode is provided on the load part at a position other than a position corresponding to a disposition position of the spring part.

12. An actuator comprising:
the spring unit according to claim 1; and
a power supply connected to the support part and to the load part via a conductor wire, wherein
the spring part is formed of an electrically insulating material, and
the support part and the load part are formed of an electrically conductive material.

13. A method for producing a spring unit, the spring unit comprising:
a spring part comprising a plurality of leaf springs each having a plate shape; and
a plate-shaped support part and a plate-shaped load part connected to opposite ends of each of the leaf springs in a first direction, wherein
each of the leaf springs is defined by a plurality of sheet-shaped members laminated on one another in a thickness direction thereof, and
the plurality of sheet-shaped members are bonded together by intermolecular force, the method comprising:
removing, from a base material, a portion thereof other than the spring part, the support part, and the load part, the base material including the sheet-shaped members being laminated on one another.

14. The method for producing a spring unit according to claim 13, wherein the base material is highly oriented pyrolytic graphite.
